(19) United States
(12) Patent Application Publication
(10) Pub. No.: US 2025/0063067 A1
(43) Pub. Date: Feb. 20, 2025

(54) CONTENT SECURITY METHOD AND SYSTEM

(71) Applicant: OpenFin Inc., New York, NY (US)

(72) Inventor: Chuck Doerr, New York, NY (US)

(73) Assignee: OpenFin Inc., New York, NY (US)

(21) Appl. No.: 18/451,075

(22) Filed: Aug. 16, 2023

(51) Int. Cl. H04L 9/40

(52) U.S. Cl. CPC H04L 63/20; H04L 63/168

(57) ABSTRACT

Disclosed is a method and system for content security. The method includes applying a content security policy to an internet browser application, wherein the content security policy is associated with a desktop manager of the internet browser application. The method further includes detecting, by a processing device executing the content security policy, a data transmission to or from the internet browser application that violates a first policy provision of the content security policy. The method further includes blocking, by the processing device, the data transmission. The method further includes transmitting an alert to a computing device that the data transmission was blocked.

### TECHNICAL FIELD

This disclosure generally relates to digital content security. In particular, this disclosure relates to web browser content security policies.

### BACKGROUND

In many settings, including enterprise and commercial networks, the use of web-based applications is an important part of any company's workflow. Web-based applications are used every day by businesses and individuals to increase productivity and save money, resources, and time in their business. However, with increased use of web-based applications comes increased security risks posed by operations performed by the web-based applications and the utilities with which they are associated. Some security risks involve unwanted data connections created or initiated by the web-based applications or unwanted data downloads on the computer operating the web browser accessing the web-based application.

Content security policies are software-based security policies applied to web browsers to prevent cross-site scripting (XSS), clickjacking (a malicious technique of tricking a user into clicking on something different from what the user perceives), and other code injection attaches resulting from the execution of malicious content in the trusted web page context. Content security policies provide a standard method for website owners to declare approved origins of content that browsers should be allowed to load on a given website. In current practice, content security policies are applied to web browser applications by the web application after the web browser connects to the web application.

### BRIEF DESCRIPTION OF THE DRAWINGS

Embodiments and implementations of the present disclosure will be understood more fully from the detailed description given below and from the accompanying drawings of various aspects and implementations of the disclosure, which, however, should not be taken to limit the disclosure to the specific embodiments or implementations, but are for explanation and understanding only.

FIG. 1 is a diagram illustrating an example communications network in accordance with an implementation;

FIG. 2 is a diagram illustrating a communications network in accordance with one or more embodiments of the disclosure;

FIG. 3 is a diagram illustrating a communications network in accordance with one or more embodiments of the disclosure;

FIG. 4 is a block diagram of a content security system in accordance with one or more embodiments of the disclosure;

FIG. 5 is a flow diagram of a method in accordance with one or more embodiments of the disclosure; and

FIG. 6 is a block diagram of a computing device that may perform one or more of the operations described in accordance with one or more embodiments of the disclosure.

### DETAILED DESCRIPTION

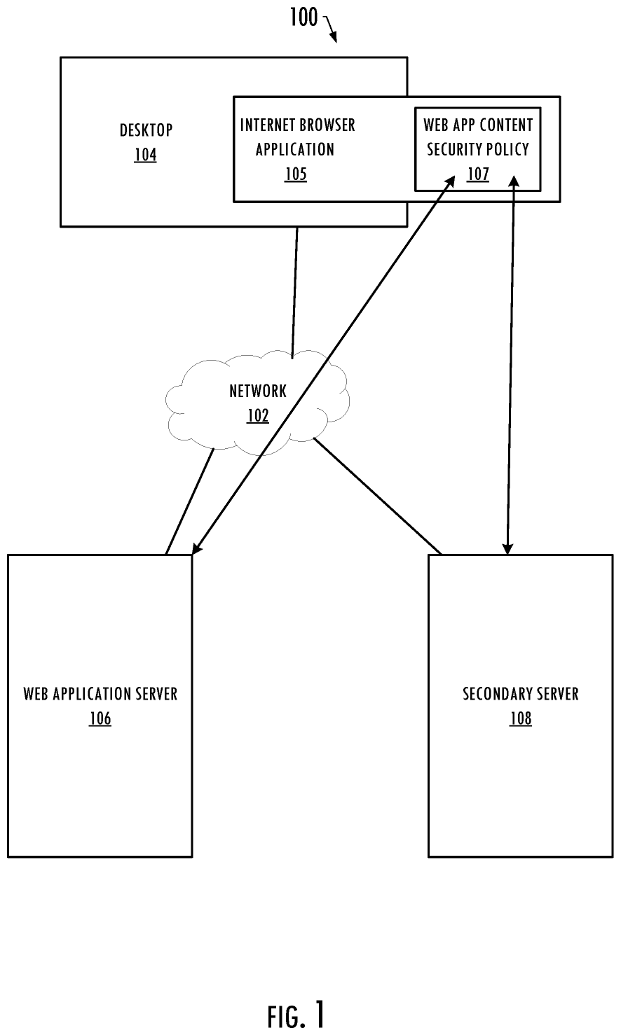

As described above, currently web applications may send, as part of the establishment of the communication with the web browser, a content security policy (CSP) to the web browser for execution and to provide some level of security while the browser is communicating with the web application. FIG. 1 illustrates an example communications network 100 including a network 102, such as the Internet or other suitable network, that connects a desktop 104 to a web application server 106 (referred to hereinafter as “web application server” or “web app server”) or a secondary server 108. Although the desktop is labeled as such, the desktop can be any suitable computing device that operates an internet browser application 105 (referred to hereinafter as “internet browser application”, “internet browser”, or “browser”). For example, the desktop 104 may be a desktop personal computer (PC), mobile device, tablet computer, personal data assistant, or any other suitable device. As shown in the figure, when the desktop connects to the web application server to access the web application operating thereon, the web application server may send a web application content security policy 107 (referred to hereinafter as “web application content security policy”, “web app content security policy”, or “web app CSP”) to the desktop browser for download.

The web app CSP 107 is managed by the web app server 106, but its execution is performed by a processing device of the desktop 104. That is the web app server sends the web app CSP to the browser 105 of the desktop and the browser downloads and installs the web app CSP, and the desktop processing device executes that web app CSP. By execution the present disclosure means the processing device executes the instructions that make up the web app CSP and the processing device blocks connections and communications that violate the instructions from the web app CSP. While this provides some security, an administrator of the desktop, who may require additional security of their own, does not have the ability to control the web app content security policy. This creates a scenario where the administrator may desire for certain connections between the browser and other devices (such as a secondary server 108) to be blocked, but the administrator cannot revise the web app CSP to have those certain connections blocked. In some cases, the web application server may not send a web app CSP at all to the desktop. In which case, there is no security controls for the connections between the browser and other devices. There is therefore a desire for a system with a CSP for the browser that is controlled by a desktop manager controlled by the administrator and is separate and distinct from the web app CSP sent by the web app server.

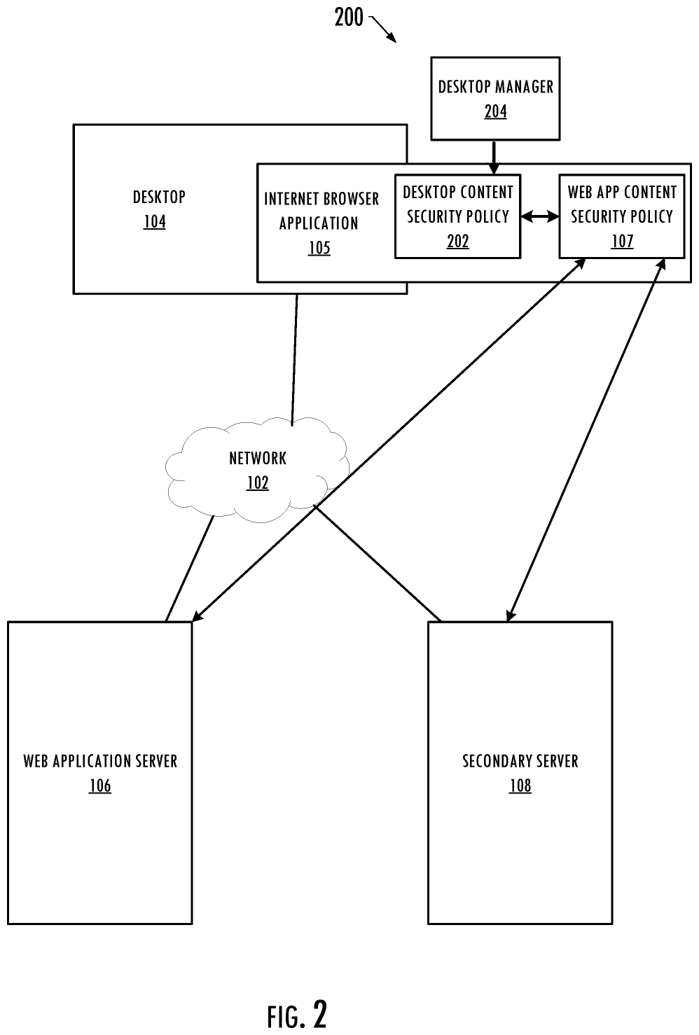

FIG. 2 illustrates a communications network 200 in which the browser 105 has installed thereon the web app CSP 107 as well as a desktop CSP 202 that is overlayed on top of the web app CSP 107 and managed by a desktop manager 204. The desktop manager is a separate computing device, such as a centralized server in communication with the desktop 104. The desktop manager can be a central server in a local area network (LAN) associated with the desktop 104, a cloud server in communication with the desktop 104, a remote computing device in communication with the desktop, a database or any other suitable computing device that can store and send data such as the desktop CSP to be applied on the browser of the desktop. The desktop manager can be configured to push one or more policies to the desktop 104 to be loaded to the browser 105. For example, the desktop manager 204 can be a server in communication with one or more desktops and configured to push or transfer one or more policies, such as a CSP (e.g., desktop CSP 202) to the one or more desktops for downloading to their browsers. The desktop manager can be a server controlled or managed by the administrator who can generate one or more CSPs for each desktop and use the desktop manager to push the generated CSPs to the desktop. That is, in addition to the web app CSP, a separately managed CSP (e.g., managed by the administrator and pushed to the desktop via the desktop manager 204) is installed by the desktop manager that can block connections and other data traffic that is not desired by the manager of the desktop 104. In some embodiments, there can be multiple desktops, each with their own browser and web app CSP installed thereon. The desktop manager can push a copy of the desktop CSP 202 to each of the desktops to be installed on their respective browsers and executed by their respective processing devices.

In this embodiment, if a particular connection is not blocked according to the web app CSP 107, the desktop CSP 202 is still being executed by the processing device of the desktop 104 and the processing device, following the instructions of the desktop CSP, can block the connections that violate the desktop CSP. For example, if the web app CSP 107 does not block connections between the browser 105 and the secondary server 108, there would be nothing CSP-wise stopping such connections from occurring. However, because the desktop CSP is applied to the browser in FIG. 2, and executed by the processing device of the desktop, the desktop CSP can be designed to block the connection between the browser 105 and the secondary server 108. This can be managed by the desktop manager. That is, in some embodiments, the desktop CSP can work in addition to the web app CSP and allow connections and data transfers to be blocked that would not ordinarily be blocked by the web app CSP alone.

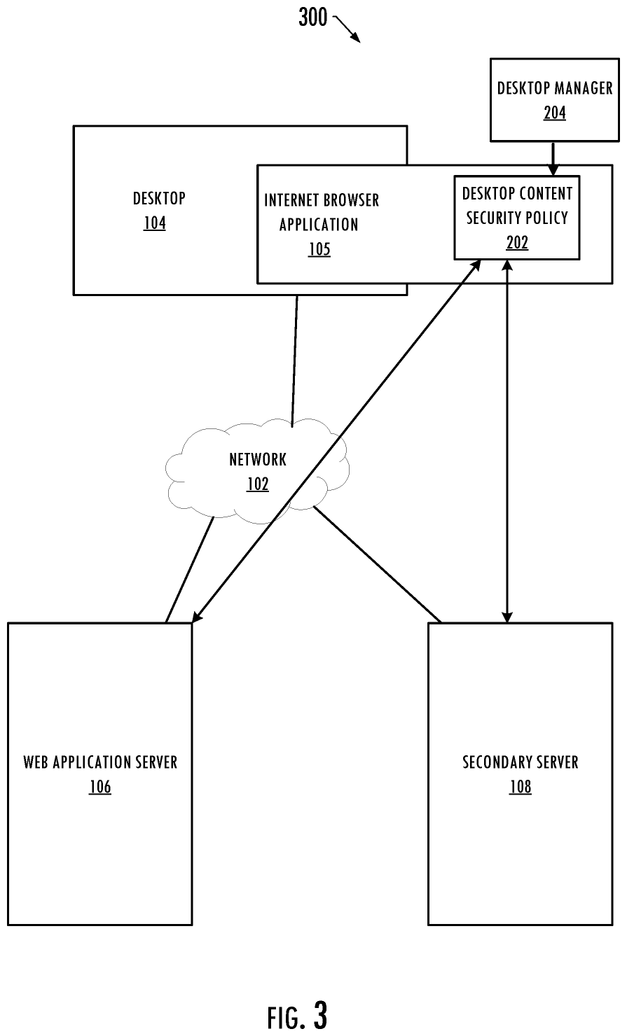

FIG. 3 illustrates another communications network 300 that is similar to FIGS. 1 and 2 above. However, in FIG. 3, the only CSP installed on the browser 105 is the desktop CSP 202 managed by the desktop manager 204. Here, the only connections blocked are those that the desktop CSP are designed to block. So, the desktop manager 204 has complete control over what connections are allowed.

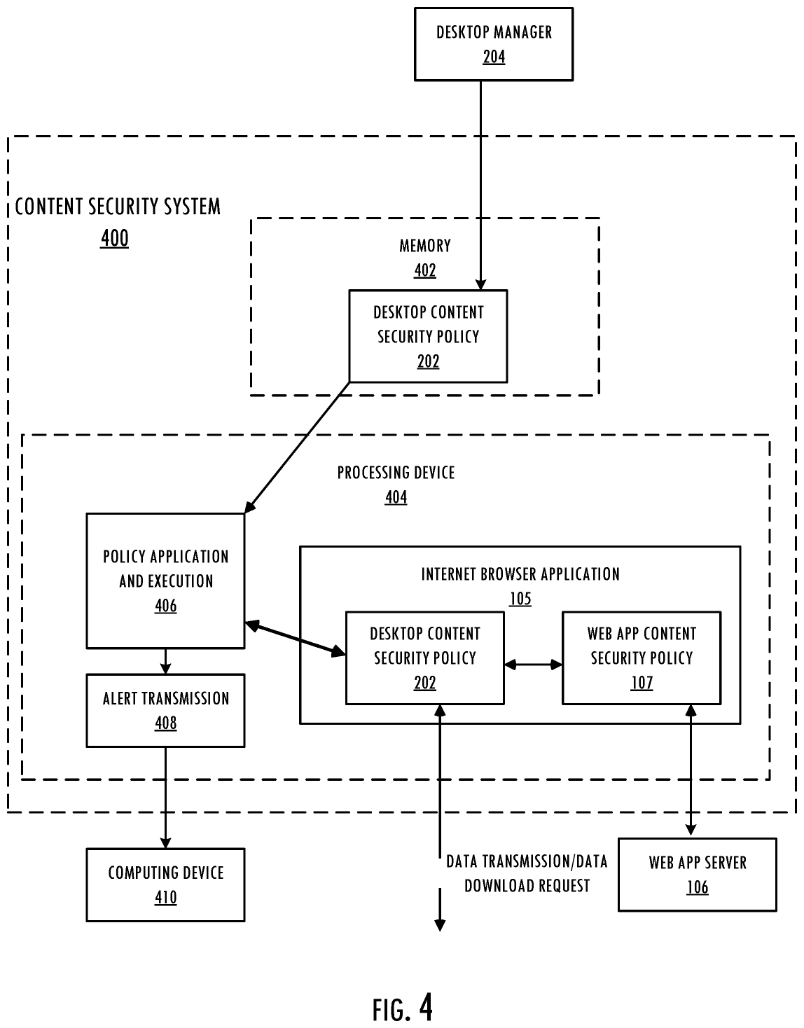

FIG. 4 illustrates a system 400 for content security. In some embodiments, the system comprises a memory 402 for storing a content security policy, for example desktop CSP 202 obtained from, or associated with, the desktop manager 204. The desktop manager 204 is associated with an internet browser application 105, such as the browsers shown in FIG. 2 or FIG. 3. That is, the desktop manager 204 is in communication with the content security system 400 and provides the desktop CSP 202 thereto, which is then stored in the memory 402. The system further includes a processing device 404 to access the desktop CSP 202 from the memory 402 and apply the CSP (i.e., the desktop CSP 202) to the internet browser application 105 and execute the CSP. The processing device may also operate or execute the internet browser application. As described above, a user may then access, using the browser 105, the web application on the web app server 106.

After the desktop CSP 202 is applied by the policy application and execution block 406 of the processing device 404, the processing device monitors communications (e.g., data transmissions, downloads, etc.) to and from the browser. In some embodiments, the processing device is to detect a data transmission to or from the internet browser application that violates a first policy provision of the content security policy. For example, if the desktop CSP contains a provision whereby any transmissions to or from a particular device, and the desktop CSP includes instructions to block such a data transmission, the processing device is to block the data transmission that violates the desktop CSP. Additionally, in some embodiments, using the alert transmission block 408 the processing device is further to transmit an alert to a computing device 410 that the data transmission was blocked. The alert can be in the form of an email or other text-based message that informs a user of the computing device 410 that the communication was blocked by the processing device according to the rules in the desktop CSP 202 applied.

In some embodiments, a ticketing system is automatically updated to include an entry corresponding to the alert. For example, in some embodiments, the desktop manager 204 from FIG. 2, can receive an indication that an alert has been triggered. In response to the desktop manager being informed that the alert has been triggered (e.g., by a message from desktop that an alert has been triggered), the desktop manager 204 (or any other suitable computing device) can automatically generate and maintain a ticketing system that includes generating one or more tickets to track a work order to address or review the alert. For example, the ticketing system can be used to track one or more alerts that are triggered by one or more data connections blocked by the desktop CSP 202. The ticketing system can be automatically populated with tickets associated with a corresponding alert for review. The ticketing system can maintain and track the tickets for each alert and each ticket can contain a plurality of details regarding its corresponding alert, for example, the type of alert, type of connection blocked, an IP address of the initiator of the connection, and various other data points. Additionally, the ticketing system can be automatically populated to include a new ticket each time an alert is triggered or generated.

In some embodiments, the processing device 404 is further to detect a data download request to the internet browser application 105 that violates a second policy provision of the content security policy (i.e., desktop CSP 202), wherein the data download request is received from a web application server 106 in communication with the internet browser application 105. The processing device 404 is further to block the data download request and then transmit an alert to the computing device 410 that the data download request was blocked.

In some embodiments, the content security policy (i.e., desktop CSP) includes one or more policy provisions to block: data transmissions or connections from the internet browser application 105 to a predefined computing device, such as another server other than the web server 106. In some other embodiments, the CSP includes one or more policy provisions to block data download requests to the internet browser application, the data download requests including requests for downloading one or more predefined types of data. In some embodiments, the content security policy includes one or more application-layer policy provisions that block one or more types of data connections. By application-layer, the present disclosure is referring to the application layer of the Open Systems Interconnection (OSI) network model. Per the OSI model, the application-layer is at layer 7. That is, the CSPs described herein can operate at layer 7 of the OSI model.

In some embodiments, the one or more types of data connections, data transmissions, or data download requests include one or more of a web services or web application connection, a web socket connection, or a web real-time communication (RTC) connection. In some embodiments, the data connections can include downloads for images, scripts, web socket connections, and any other standard web connection or download.

As described above, in some embodiments, the browser will have applied thereon a desktop CSP 202 from the desktop manager as well as a web app CSP 107 from a web app server 106. That is, in some embodiments, the content security policy (i.e., desktop CSP) is a first content security policy applied to the internet browser application, and a second content security policy (i.e., the web app CSP 107) is applied to the internet browser application by a web application (operating on the web app server 106) with which the internet browser application is in communication. As described above with respect to FIG. 2, the first content security policy (i.e., the desktop CSP 202) and the second content security policy (i.e., the web app CSP 107) are separately managed by the desktop manager 204 and the web app server 106, respectively. In some embodiments, the web app CSP 107 is already installed on the browser 105 and the one or more processors 404 overlays the desktop CSP 202 on top of the web app CSP. That is, the desktop CSP 202 works in combination with the web app CSP. The desktop manager 204 facilitates the overlay of the desktop CSP on the web app CSP by pushing the desktop CSP to the memory 402 of the content security system 400 for execution on the browser.

FIG. 4 illustrates data transmission or data download request coming into the browser 105 separately from the web app server 106, but the request could come directly from thee web app server 106 as well. That is, the desktop CSP 202 can be used to block data connections or transmissions between the browser and the web app server, any device that the web app server tells the browser to connect to, or any other device unrelated to the web app server. As described above, with respect to FIG. 2, the two CSP's (i.e., desktop CSP and the web app CSP) can work in tandem such that traffic that is received by the browser is analyzed by the processing device 404 to check for compliance with both CSPs.

As described above, the benefits of including the desktop CSP 202 overlayed on top of the web app CSP 107 is that an administrator of the content security system 400 can provide additional security measures to block undesirable connections that the web app CSP 107 might not consider harmful. For example, if the web app server 106 instructions the browser 105 to create another connection with a third party server, the administrator of the content security system may not desire to make that connection. In this case, the desktop CSP can include a provision, provided by the administrator of the desktop manager 204, that blocks the undesired connection. That is, with the implementation of the desktop CSP 202, overlayed on top of the web app CSP, the administrator has significant flexibility in managing security for connections between the browser and other devices. The administrator can use the desktop manager to push the desktop CSP to multiple desktops in the enterprise network, and all devices on the network can be protected as desired.

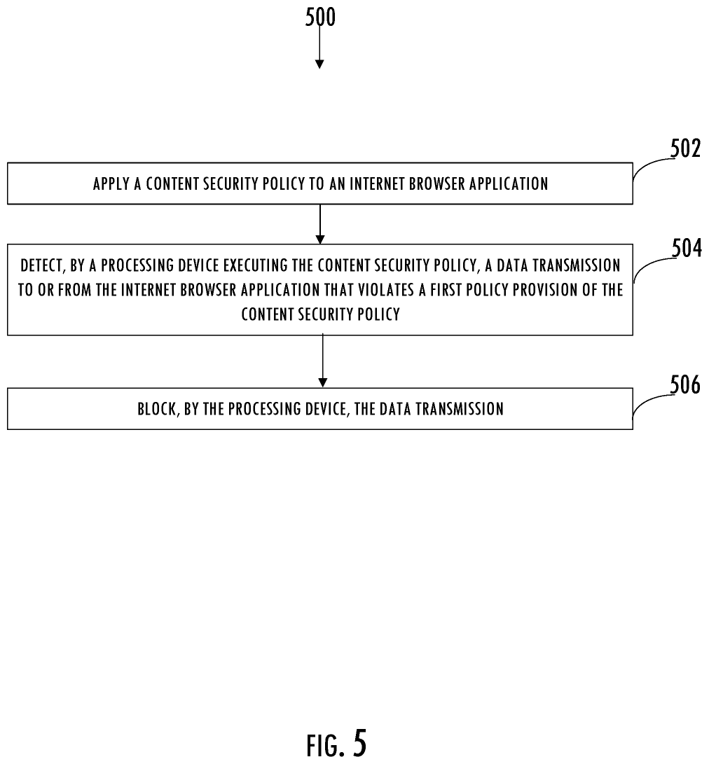

FIG. 5 is a flow diagram of an example method 500 for content security. As shown in block 502, the method includes applying a content security policy to an internet browser application, wherein the content security policy is associated with a desktop manager of the internet browser application. Furthermore, as shown at block 504, the method includes detecting, by a processing device executing the content security policy, a data transmission to or from the internet browser application that violates a first policy provision of the content security policy. Finally, as shown at block 506, the method includes blocking, by the processing device, the data transmission.

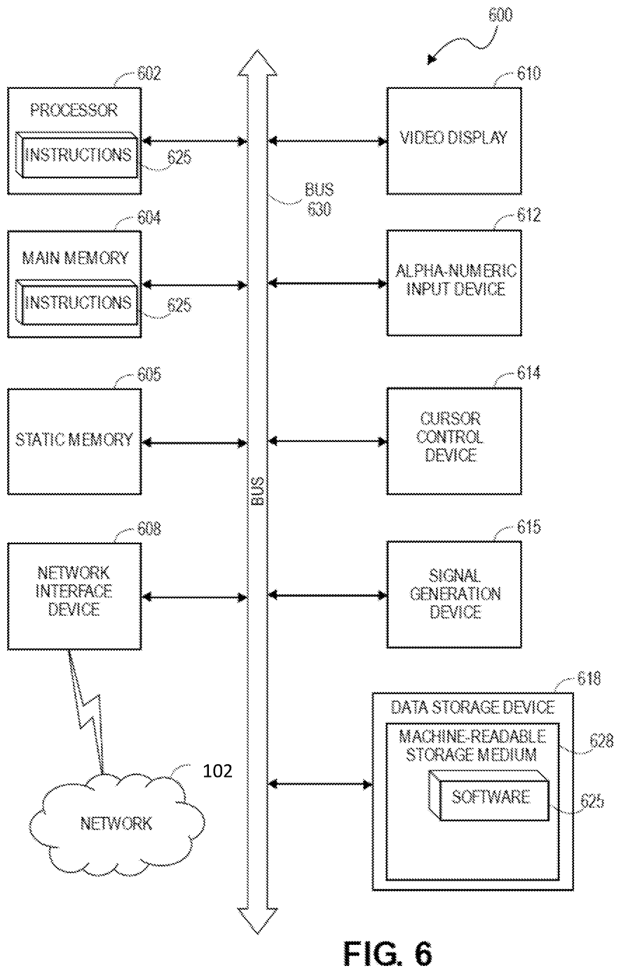

FIG. 6 is a block diagram of an example computing device 600 that may perform one or more of the operations described herein (such as the operations of the processing device 404 described in FIG. 4), in accordance with some embodiments. More particularly, computing device 600 may be integrated in or separate from any of the servers or devices described above to perform any of the described operations. Computing device 600 may be connected to other computing devices in a local area network (LAN), an intranet, an extranet, or the Internet. The computing device may operate in the capacity of a server machine in the client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 600 may include a processing device (e.g., a general purpose processor, a PLD, etc.) 602, a main memory 604 (e.g., synchronous dynamic random access memory (DRAM), read-only memory (ROM)), a static memory 605 (e.g., flash memory and a data storage device 618), which may communicate with each other via a bus 630.

The processing device 602 may be provided by one or more general-purpose processing devices such as a microprocessor, central processing unit, or the like. In an illustrative example, processing device(s) 602 may comprise a complex instruction set computing (CISC) microprocessor, reduced instruction set computing (RISC) microprocessor, very long instruction word (VLIW) microprocessor, or a processing device implementing other instruction sets or processors implementing a combination of instruction sets. Processing device(s) 602 may also comprise one or more special-purpose processing devices such as an application specific integrated circuit (ASIC), a field programmable gate array (FPGA), a digital signal processor (DSP), network processor, or the like. The processing device(s) 602 may be configured to execute the operations described herein, in accordance with one or more aspects of the present disclosure, for performing the operations and steps discussed herein.

Computing device 600 may further include a network interface device 608 which may communicate with a network 102. The computing device 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and an acoustic signal generation device 615 (e.g., a speaker). In one embodiment, video display unit 610, alphanumeric input device 612, and cursor control device 614 may be combined into a single component or device (e.g., an LCD touch screen).

Data storage device 618 may include a non-transitory computer-readable storage medium 628 on which may be stored one or more sets of instructions 625 that may include instructions for carrying out the operations described herein, in accordance with one or more aspects of the present disclosure. Instructions 625 may also reside, completely or at least partially, within main memory 604 or within processing device(s) 602 during execution thereof by computing device 600, main memory 604 and processing device(s) 602 also constituting computer-readable media. The instructions 625 may further be transmitted or received over a network 620 via network interface device 608.

While computer-readable storage medium 628 is shown in an illustrative example to be a single medium, the term “computer-readable storage medium” should be taken to include a single medium or multiple media (e.g., a centralized or distributed database or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method of content security comprising:
applying a content security policy to an internet browser application, wherein the content security policy is associated with a desktop manager of the internet browser application;
detecting, by a processing device executing the content security policy, a data transmission to or from the internet browser application that violates a first policy provision of the content security policy; and
blocking, by the processing device, the data transmission.

2. The method of claim 1, further comprising transmitting an alert to a computing device that the data transmission was blocked.

3. The method of claim 1, further comprising:
detecting, by the processing device, a data download request to the internet browser application that violates a second policy provision of the content security policy, wherein the data download request is received from a web application server in communication with the internet browser application;
blocking, by the processing device, the data download request; and
transmitting an alert to the computing device that the data download request was blocked.

4. The method of claim 3, wherein the content security policy includes one or more policy provisions to block:
data transmissions or connections from the internet browser application to a predefined computing device; or
data download requests to the internet browser application, the data download requests including requests for downloading one or more predefined types of data.

5. The method of claim 1, wherein the content security policy includes one or more application-layer policy provisions that block one or more types of data connections.

6. The method of claim 5, wherein the one or more types of data connections include at least one of:
a web services or web application connection;
a web socket connection; or
a web real-time communication (RTC) connection.

7. The method of claim 1, wherein the content security policy is a first content security policy applied to the internet browser application, and wherein a second content security policy is applied to the internet browser application by a web application with which the internet browser application is in communication.

8. The method of claim 7, wherein the first content security policy and the second content security policy are separately managed by the desktop manager and a web server associated with the web application, respectively.

9. A system for content security comprising:
a memory to store a content security policy, wherein the content security policy is associated with a desktop manager of an internet browser application; and
a processing device operatively coupled with the memory to:
apply the content security policy to the internet browser application and execute the content security policy;
detect a data transmission to or from the internet browser application that violates a first policy provision of the content security policy; and
block the data transmission.

10. The system of claim 9, wherein the processing device is further to transmit an alert to a computing device that the data transmission was blocked.

11. The system of claim 9, wherein the processing device is further to:
detect a data download request to the internet browser application that violates a second policy provision of the content security policy, wherein the data download request is received from a web application server in communication with the internet browser application;
block the data download request; and
transmit an alert to the computing device that the data download request was blocked.

12. The system of claim 11, wherein the content security policy includes one or more policy provisions to block:
data transmissions or connections from the internet browser application to a predefined computing device; or
data download requests to the internet browser application, the data download requests including requests for downloading one or more predefined types of data.

13. The system of claim 9, wherein the content security policy includes one or more application-layer policy provisions that block one or more types of data connections.

14. The system of claim 13, wherein the one or more types of data connections include one or more of:
a web services or web application connection;
a web socket connection; or
a web real-time communication (RTC) connection.

15. The system of claim 9, wherein the content security policy is a first content security policy applied to the internet browser application, and wherein a second content security policy is applied to the internet browser application by a web application with which the internet browser application is in communication.

16. The system of claim 15, wherein the first content security policy and the second content security policy are separately managed by the desktop manager and a web server associated with the web application, respectively.

17. A non-transitory computer readable storage medium to store instructions executable by a processing device of a system to cause the system to:
apply a content security policy to an internet browser application, wherein the content security policy is associated with a desktop manager of the internet browser application;
detect, by the processing device executing the content security policy, a data transmission to or from the internet browser application that violates a first policy provision of the content security policy; and
block, by the processing device, the data transmission.

18. The non-transitory computer readable storage medium of claim 17, wherein the processing device is further to transmit an alert to a computing device that the data transmission was blocked;
wherein the content security policy includes one or more application-layer policy provisions that block one or more types of data connections.

19. The non-transitory computer readable storage medium of claim 17, wherein the processing device is further to:
detect a data download request to the internet browser application that violates a second policy provision of the content security policy, wherein the data download request is received from a web application server in communication with the internet browser application;
block the data download request; and
transmit an alert to the computing device that the data download request was blocked.

20. The non-transitory computer readable storage medium of claim 19, wherein the content security policy includes one or more policy provisions to block:
data transmissions or connections from the internet browser application to a predefined computing device; or
data download requests to the internet browser application, the data download requests including requests for downloading one or more predefined types of data.
